(19) United States
(12) Patent Application Publication
(10) Pub. No.: US 2015/0019291 A1
(43) Pub. Date: Jan. 15, 2015

(54) METHOD AND SYSTEM FOR SELECTIVE ACCESS TO SUPPLIER IDENTITY, PERFORMANCE AND QUALITY VALUES AND VISUAL PRESENTATION OF RELATIVE SUPPLIER PERFORMANCE VALUES

(71) Applicants: ALEXANDER GERSHENSON, SANTA CRUZ, CA (US); JAMES BARSIMANTOV, SANTA CRUZ, CA (US)

(72) Inventors: ALEXANDER GERSHENSON, SANTA CRUZ, CA (US); JAMES BARSIMANTOV, SANTA CRUZ, CA (US)

(21) Appl. No.: 14/265,291

(22) Filed: Apr. 29, 2014

Related U.S. Application Data
(60) Provisional application No. 61/817,316, filed on Apr. 29, 2013.

(51) Int. Cl. G06Q 30/02

(52) U.S. Cl. CPC G06Q 30/0203
USPC 705/7.32

(57) ABSTRACT

A method and system for suppliers and buyers to share quality factor measures in a trusted electronically mediated environment. Selective anonymity of participants is enabled and data may be accessed without disclosure of either (a.) the party providing the data or (b.) the entity to which the data applies. Participants may request communications with anonymous parties related to accessible but non-associated parametric values, wherein a buyer may see the quality parameter values of a potential supplier but without learning the identity of the supplier. The buyer, or other participant, may disclose their identity to an anonymous potential supplier and request an initiation of communications with the anonymous party. The invented method is applicable beyond supply chain environments and is generally useful in multi-party environments designed for responsibly sharing sensitive information.

### CO-PENDING APPLICATION

The present application is a Continuation-in-Part Application of U.S. Provisional Patent Application Ser. No. 61/817,316 filed on Apr. 29, 2013 and titled METHOD AND SYSTEM FOR SELECTIVE ACCESS TO SUPPLIER IDENTITY, PERFORMANCE AND QUALITY AND VISUAL PRESENTATION OF RELATIVE SUPPLIER PERFORMANCE VALUES, wherein the present application claims benefit of the priority date of the filing of this U.S. Patent Application Ser. No 61/817,316 filed on APRIL 29, 2013. Furthermore, the U.S. Patent Application Ser. No. 61/817,316 filed on APRIL 29, 2013 and titled METHOD AND SYSTEM FOR SELECTIVE ACCESS TO SUPPLIER IDENTITY, PERFORMANCE AND QUALITY AND VISUAL PRESENTATION OF RELATIVE SUPPLIER PERFORMANCE VALUES is incorporated in its entirety with the present application in its entirety and for all purposes.

### FIELD OF THE INVENTION

The present invention relates to performance data and quality measures related to supply chain management. More particularly, the present invention relates to communications and analyses related to evaluation of supplier performance by means of an electronic communications network.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Entities such as businesses, individuals and organizations have been increasingly burdened with requests for information from potential clients, customers, strategic partners, governments and other enquiring parties. The growing ubiquity of role of respondent has been especially influenced by the growth and influence of information technology.

Enquirers such as purchasing agents in particular and others involved in evaluating and selecting suppliers, e.g., vendors, in the business to business marketing context are increasingly devoted to gathering information about existing and potential suppliers to enhance buyer management of their current suppliers, improve evaluation of potential suppliers, and to compare the relative performance of selected suppliers with a general population of similar suppliers. It is commonplace now for respondent-suppliers to receive requests for information from current and potential customers in this regard, wherein honest and thorough self-reporting is expected by the enquiring customers and potential customers. While most suppliers recognize the validity of an expectation that reasonable enquiries by buyers should be fully responded to, many suppliers are concerned about making public releases of certain operational or performance data to the general public whereby competitors and others with possible adverse interests may have access to these admissions. In addition, much publicly available data can be associated with known suppliers, but the prior art fails to provide means to efficiently integrate existing data and access thereto with individual buyers requests for information, whereby opportunities for broadening data reliability are lost. The prior art also generally fails to collate similar quality data that essentially informs buyers of a same supplier quality parameter and thus not unusually leaves suppliers with a burden of answering similar but numerous quality level questions that could be effectively addressed by reference to a single value and as routinely reported by a supplier.

Furthermore, most purchasing agents are uniquely interested in particular quality parameters and often weight these parametric values in individualistically selected emphasis. Yet the parametric quality data that many firms seek often has much crossover, whereby a plurality of parametric value may be routinely requested in a majority or large plurality of buyer enquiry submissions received by suppliers. The prior art fails to provide a centralized and trusted data depository that would reduce the need for suppliers to needlessly repetitively provide the same or similar material in numerous duplicative response to buyer enquiries.

In addition, the prior art fails to optimally enable efficient methods and channels for suppliers to share operational and performance data with buyers in a context that enables selective anonymity of the suppliers and an assurance that enquiring parties have good cause for requesting access to this data. Furthermore, the prior art fails to enable suppliers to anonymously compare their own performance and operational data to determine their own ranking of supplier quality parameters in comparison with peer-competitor firms.

The prior art also fails to provide optimal methods to visually present non-normative relative parametric data of a set or plurality of entities, such as suppliers or other parties

There is therefore a long-felt need to provide more uniformity to the interaction of enquirers and respondents in gathering information about the respondent or the respondents' affiliation, e.g., a corporation, agency or organization. In addition, there is a long felt need to provide methods and systems that enable communications efficiencies between buyers and suppliers in providing information related to the evaluation of the seller by the buyer. It is understood that the present invention is applicable to a wide scope of parametric value correlation, relatedness and evaluation in the context of sharing data among parties and optionally enabling at least partly selective anonymity of participants.

### SUMMARY AND OBJECTS OF THE INVENTION

Towards these objects and other objects that are made obvious in light of the present disclosure, a method and system are provided that enable increased efficiency in providing information provided to an enquirer in response to one or more queries communicated as directed by the enquirer to the respondent.

In a first optional aspect of the invented method, a library of preformatted and prestructured queries are maintained in a database and made available for enquiries addressed to respondents, e.g., suppliers. Both enquirers and respondents, e.g., buyers and suppliers, may access this library of preformatted and standardized queries to generate scorecards, each scorecard being a selection of two or more preformatted queries. An enquiring party may form a collection of queries into a scorecard format and communicate the scorecard of queries to a respondent, e.g., a supplier, potential supplier, or other party, as a request for information to be answered, and represented as valid and accurate, by the respondent. More particularly, respondents to queries may maintain records of their own responses to scorecards, whereby the respondents can more efficiently answer a query that has been previously asked by a same or a different enquirer.

Some data of previously answered scorecards may optionally made available for both enquirers and respondents, e.g., buyers and sellers, to assess a particular answered scorecard in view of the answers of a plurality of respondents of a same collection of queries. Respondents may be enabled to self assess by comparing their own responses to queries to previous answers supplied by other respondents, e.g., sellers, to the same queries, wherein the respondents of the previous queries are kept anonymous.

In another optional aspect of the invented method, respondents and answered scorecards may be associated with an industry sector and/or type of business. For example, separate scorecards answered by a grocery store and a farm may be identified as both being related to food safety, and further respectively identified as a retail operator and as an original source of goods, i.e., food in this case. These optional distinctions of scorecard responses by each respondent's industry sector and functional nature within an identified industry enhance the ability of the invented system to make more meaningful relative comparisons of the values of a particular answered scorecard with previously answered scorecards by enabling a selection of more relevant answered scorecards to compare the particular answered scorecard. The advantage of this inventive aspect is also available in self-assessments of respondents in comparisons of their own answered scorecards enabling a comparison of their responses with responses of more similar respondents rather than with the responses of a body of undesirably diverse respondents. The enquiring party may additionally optionally direct a query to an identified or anonymous entity to obtain a parametric value. The database management system may optionally access one or more external databases, or at least partially internally integrate aspects of one or more external databases, in the interest of providing existing data to enquiring parties.

In yet another optional aspect of the invented method, a respondent's database management system maintains a plurality of parametric data value records, wherein each record stores a value related to a defined or identified parameter, e.g., a quantitative measure of timely delivery of goods of a respondent identified by, or associated with, a particular supplier. One or more parametric data value records may be associated with more than one enquiry wording, whereby the parametric value stored in the comprising record presents an intended response to two or more differently worded, but logically equivalent, enquiries.

In a still other optional aspect of the invented method, the invented database management system may associate time and/or date data with one or more parametric values as an indicator of relevance or freshness of the previously recorded parametric data value.

In an additional optional aspect of the invented method, access to data related to a particular entity requires permission by the entity or its representative. In a fourth optional aspect of the invented method, a scorecard outline is retained by a computational system, the scorecard outline listing or referencing a set of query filters of a previously executed scorecard format, whereby other parties may apply the retained scorecard outline to apply a same set of queries in an additional query of the data base management system.

In an even additional optional aspect of the invented method, the data base management system enables a view of a plurality of results of a same scorecard applied to a plurality of entities, wherein at least some of the entity identifications are masked and obfuscated to prevent immediate recognition of the related entity. By this feature, a user may direct a data base management system to generate and render a quantitative analysis of a plurality of entities in an application of a same scorecard-based query and compare the results of this same scorecard application of known entities with the parametric values of anonymous entities. In a yet additional optional aspect of the invented method, a participant may be enabled to send a message to an anonymous entity requesting an initiation of communications, wherein the anonymous entity preferably is related to at least some parametric data that has been viewed by the requesting participant.

In a further optional aspect of the invented method, an entity may direct a data base management system to compare parametric values of its own against the parametric values of similar or other entities to determine a ranking of the requesting entity versus a selected population of entities. This ranking method may mask or obfuscate the identities of one, some or all other entities selected and ranked along with the enquiring entity, whereby the possibility of a disclosure of an association of quality values and evaluations of potential competitors is reduced or eliminated, yet the enquiring entity has an opportunity to better see how it is performing and/or is perceived by other participants and the market place.

In a still additional optional aspect of the invented method, a graphical user interface (hereinafter, “GUI”) is rendered that displays non-normative distributed data. It is an object of the method of the present invention (hereinafter “invented method”) to provide a method and a system that enable communications of sensitive data within a trusted network and optionally with selective anonymity and masked relatedness of data to participants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1A is a network diagram depicting an environment and structure of a first preferred embodiment of the invented service.

FIG. 1B presents block diagrams of invented query records.

FIG. 1C is a block diagram of an exemplary invented scorecard record.

FIG. 1D is a block diagram of an exemplary invented submitted scorecard record that includes answers provided by a responding user of the respondent system of FIG. 1A.

FIG. 1E is a block diagram of a database management system of the server of FIG. 1A.

FIG. 1F is a block diagram of a buyer profile maintained in the database management system of the server of FIG. 1E.

FIG. 1G is a block diagram of a supplier profile maintained in the database management system of the server of FIG. 1E.

FIG. 1H is a block diagram of a buyer database management system of the enquirer system of FIG. 1A.

FIG. 1I is a block diagram of a supplier database management system of the respondent system of FIG. 1A.

FIG. 2 is a software flowchart of the enquirer system of FIG. 1A forming a new scorecard record as directed by a first user of the enquirer system.

FIG. 3 is a software flowchart of the server of FIG. 1A responding to the enquirer system of FIG. 1A and processing a scorecard query process in communication with the respondent system of FIG. 1A.

FIG. 4 is a representation of the respondent system of FIG. 1A responding to receipt of query data N as directed by a responding user.

FIG. 5A is a block diagram of an exemplary scorecard request message.

FIG. 5B is a block diagram of an exemplary score card message.

FIG. 5C is a block diagram of an exemplary response message.

FIG. 5D is a block diagram of an exemplary reply message

FIG. 6 is a flowchart of a comparison process wherein an enquiring party of FIG. 1A may compare query and scorecard answers of a known supplier with other unidentified suppliers without disclosing the identities of the unidentified suppliers.

FIG. 7A is a block diagram of an exemplary comparison request message.

FIG. 7B is a block diagram of a pseudonym table

FIG. 7C is a block diagram of an exemplary comparison data message.

FIG. 8 is a software flowchart of interaction of the enquirer system with the server of FIG. 1A and the enquiring user.

FIG. 9A is a block diagram of a contact request message of FIG. 8.

FIG. 9B is a block diagram of the supplier response message of FIG. 8.

Referring now generally to the Figures and particularly to FIG. 10, FIG. 10 is a representation of the enquirer system of FIG. 1A accessing selected data of the supplier profile record as enabled by the server of FIG. 1A by application of the pseudonym table of FIG. 7B and without revealing the identity of suppliers.

FIG. 11 is a flowchart of the respondent system in interaction with the server of FIG. 1A in conducting a comparison of its answers to answers provided by other suppliers of a specified industry to the same queries.

FIG. 12A is a block diagram of an exemplary self assessment message of the process of FIG. 11.

FIG. 12B is a block diagram of the second pseudonym table of the process of FIG. 1 as maintained by the server of FIG. 1A.

FIG. 12C is a block diagram of the exemplary self assessment data message of steps 11.06 and 11.08 of FIG. 11 and as sent to the respondent system of FIG. 1A from the server of FIG. 1A.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

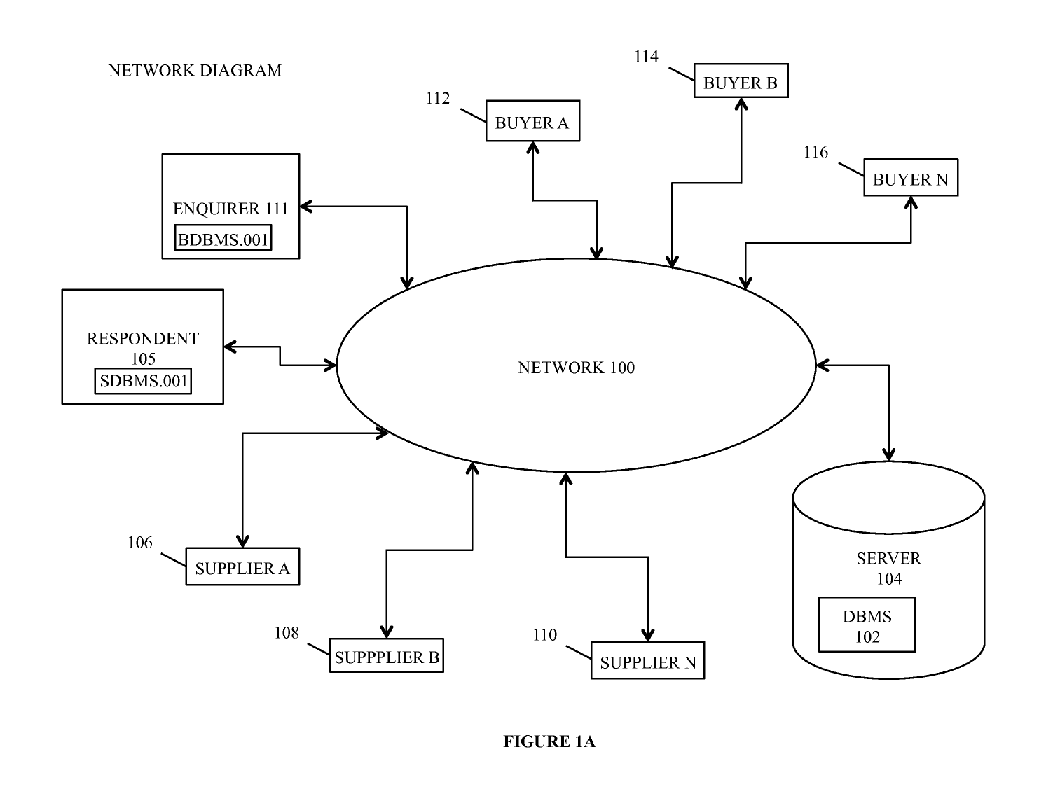

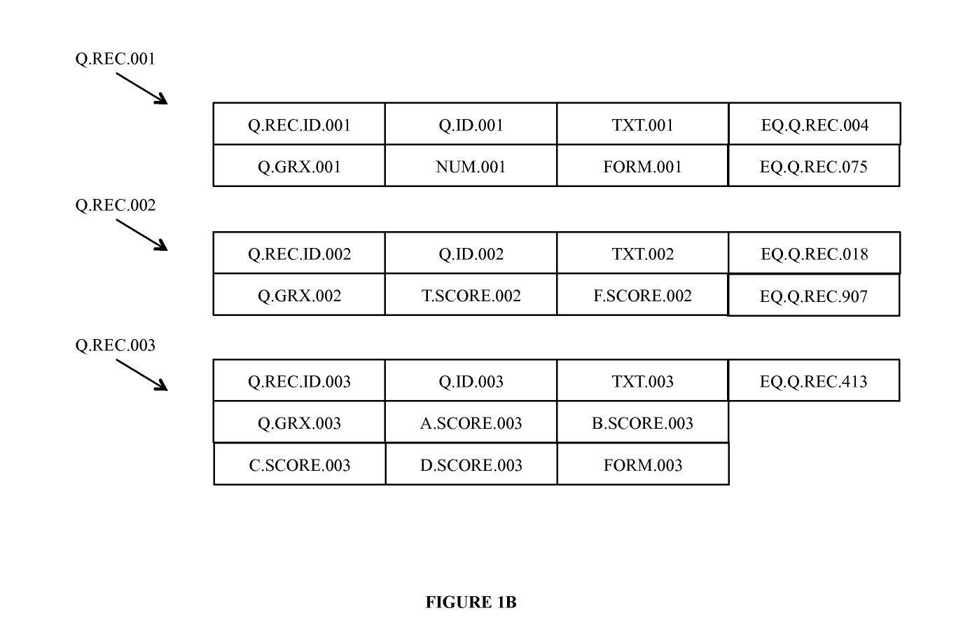

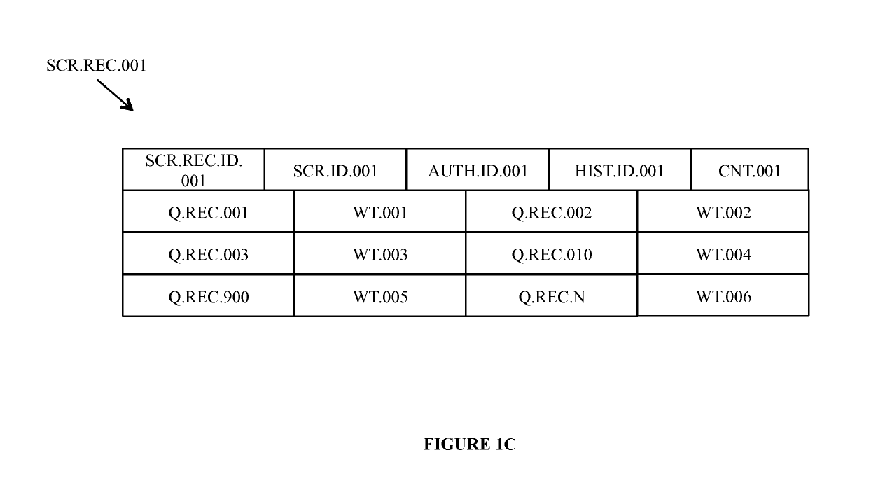

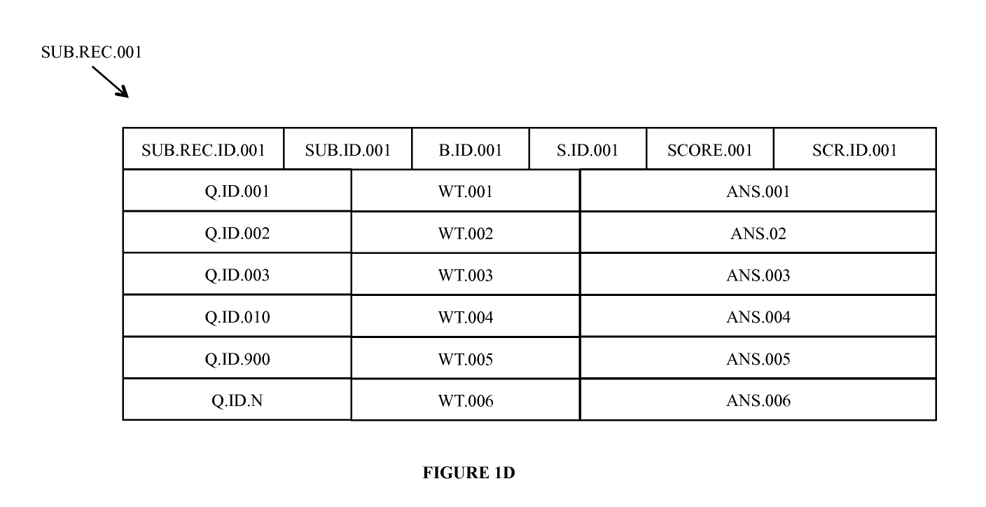

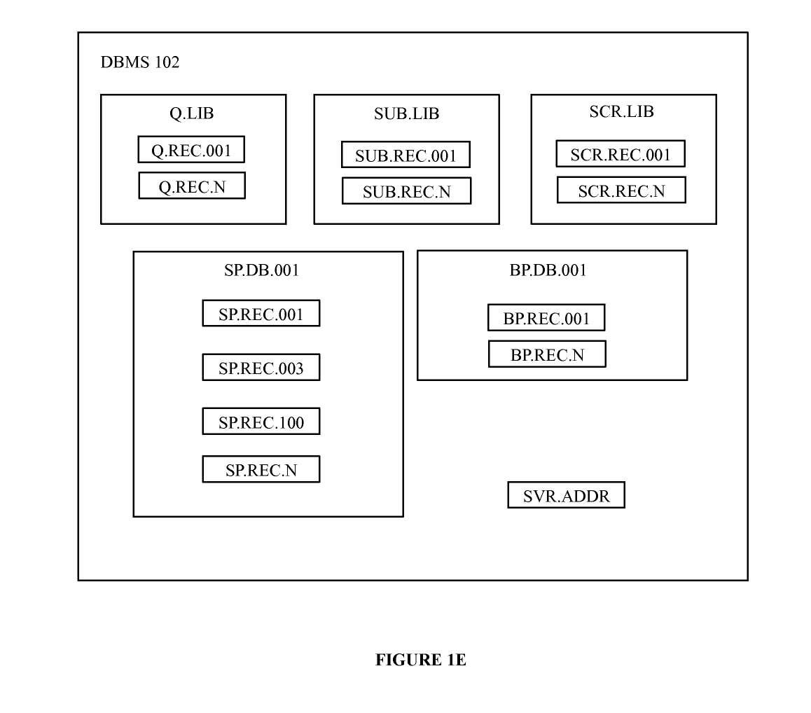

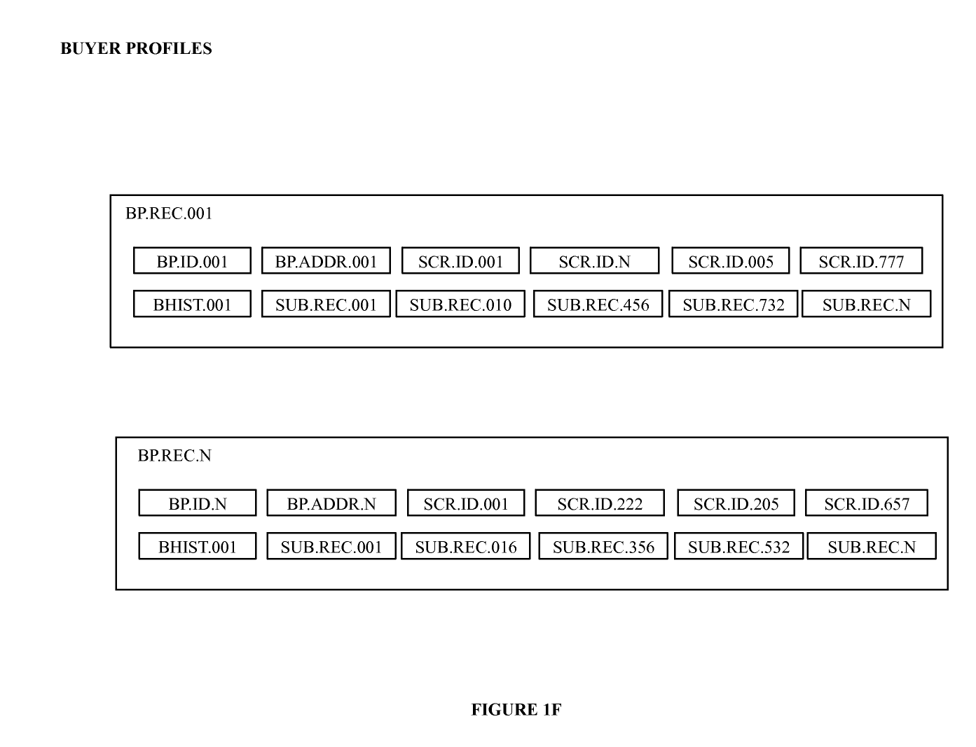

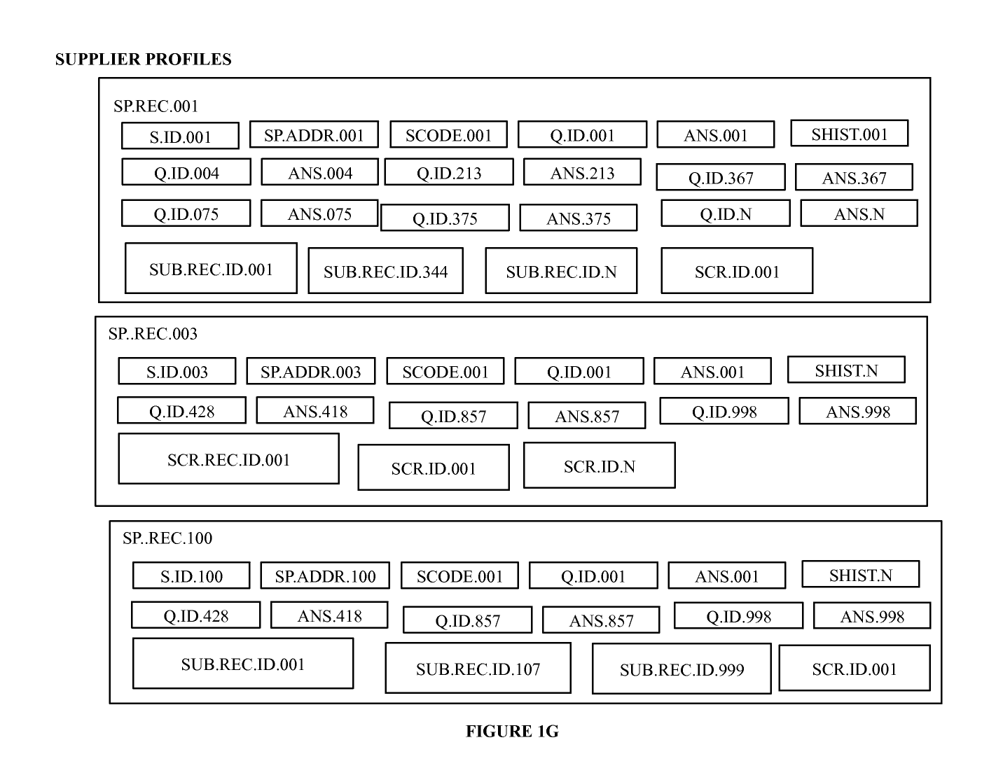

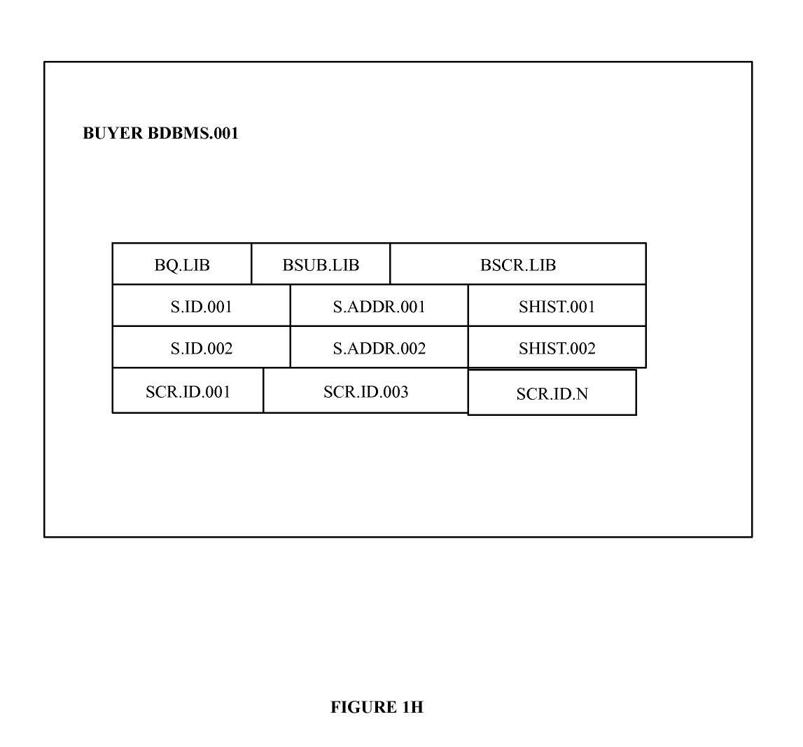

Referring now generally to the Figures and particularly to FIG. 1, FIG. 1 presents an electronic communications network 100 (hereinafter, “the network 100”) that optionally comprises the Internet and/or one or more telephony networks. The network 100 bi-directionally communicatively couples a query and scorecard database management system 102 of a system server 104, a plurality of the respondent system and the supplier systems 106, 108 & 110 (hereinafter. “supplier systems” 105-110) and a plurality of enquirer systems 111, 112, 114 & 116 (hereinafter, “buyer systems” 111-116). It is understood that the example scenarios presented herein of buyers as enquirers and suppliers as respondents are offered for the purpose of clarity and not intended as limitations of the scope of the invented method.

As discussed in reference to the Figures generally, the query and scorecard database server 104 (hereinafter, “the server 104) is managed in the invented method to enable selective access to query records Q.REC.01-Q.REC.N, scorecard records SCR.REC.01-SCR.REC.N, submitted scorecard records SUB.REC.01-SUB.REC.N derived from submitted answers to queries of scorecard records SCR.REC.001-SCR.REC.N, supplier/respondent identifiers S.ID.01-S.ID.N, buyer/enquirer identifiers B.ID.01-B.ID.N, and additional information useful in performing assessments, rankings and comparisons of answers to queries and respondent performance.

Each supplier system 106-1101 preferably maintains a library of previously answered query records Q.REC.001-Q.REC.N, scorecard records SCR.REC.001-SCR.REC.N, and submitted scorecard records SUB.REC.001-SUB.REC.N, whereby a given supplier may determine if a newly received query has been previously answered. The supplier may thus be enabled to rely on selecting and communicating a locally accessible answer in response to a previously received query of a same query record Q.REC.001-Q.REC.N. This inventive feature may be particularly valuable in large organizations wherein numerous departments may be receiving the same query from numerous buyers or other enquirers, whereby the efficiency of the invented service of determining on a remote, external server on behalf of a supplier's agent if an accurate, valid and current answer to the instant query has been made available and authorized for response by one or more individual responding employees of the organization.

Examples of embodiments of these server 104 and systems 105 through 116 would include bundled software and hardware computer products such as (a.) a network-communications enabled THINKSTATION WORKSTATION ™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running a WINDOWS™ operating system as marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea and running an ANDROID™ operating system; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable mobile electronic device, wireless communications device, computational system or electronic communications device known in the art.

Referring now generally to the Figures a first preferred embodiment (hereinafter, “the first method”) of the invented method provides for a query library Q.LIB maintained by the server 104 of query records Q.REC.01-Q.REC.N that each contain an expression of a query. As shown at least in FIG. 1B, a first query record Q.REC.001 provides a first query that is directed toward generating a numeric response. A first text data TXT.001 includes data that can be rendered as a human-readable first query. An optional first graphics data Q.GRX.001 includes image data that may be rendered in combination with or in alternate place of the first text data TXT.001 to express the human-readable first query. The exemplary first query record Q.REC.001 also includes pointers to queries Q.REC.004 & Q.REC.075, wherein the EQ designation in the first query record indicates that these other queries have equivalent answers which may be provided to an enquirer in the invented process of responding to and answering a scorecard or a query.

A first normalizing value NUM.001 may be applied to a numeric answer provided by the respondent to adjust the numeric answer to normalize the scoring process. A first formula FORM.001 may be applied to derive a normalized numeric answer by applying the first normalizing value NUM.001 to a received respondent answer to the first query. An example derivation of a normalized numeric answer might be, in accordance with a logic of the first formula FORM.001, to divide a respondent's numeric input by a normalizing value NUM.001 of 100.

The first method further provides a second query record Q.REC.002 that is directed toward a second query structured as a TRUE/FALSE query, wherein the expected respondent replies are limited to TRUE, FALSE, and NULL. A second query record Q.REC.002 includes a second text data TXT.002 that that can be rendered as a human-readable second query. An optional second graphics data Q.GRX.002 includes image data that may be rendered in combination with or in alternate place of the second text data TXT.002 to express the human-readable second query. The exemplary first query record Q.REC.001 also includes pointers to queries Q.REC.018 & Q.REC.907,

A true score datum T.SCORE.002 provides a numeric value associated with receipt of a query reply recognized as a TRUE value by the server 104. A false score datum F.SCORE.002 provides a numeric value associated with receipt of a query reply recognized as a FALSE value by the server 104. For example, a respondent selection of a TRUE value may add a numeric value of one to a total score of a scorecard SCR.001-SCR.N comprising the exemplary second query record Q.REC.002, whereas a respondent selection of a TRUE value may add a numeric value of zero to the instant total score.

The first method further provides a third query record Q.REC.003 that is directed toward a third query structured as a multiple choice query, wherein the expected respondent replies are limited to a set of four answer choices. It is understood that the exemplary four choices is chosen for the purpose of clarity of explanation and is not meant as limiting and required number of choices enabled by the invented method.

A third query record Q.REC.003 includes a third text data TXT.003 that includes data that can be rendered as a human-readable multiple-choice third query. An optional third graphics data Q.GRX.003 includes image data that may be rendered in combination with or in alternate place of the third text data TXT.003 to express the human-readable multiple-choice third query. A first multiple choice selection score datum A.SCORE.003 provides a numeric value associated by the server with a respondent selection of a first A choice of the multiple choice third query. A second multiple choice selection score datum B.SCORE.003 provides a numeric value associated by the server 104 with a respondent selection of a second B choice of the multiple choice third query. A third multiple choice selection score datum C.SCORE.003 provides a numeric value associated by the server 104 with a respondent selection of a third C choice of the multiple choice third query. A fourth multiple choice selection score datum D.SCORE.003 provides a numeric value associated by the server 104 with a respondent selection of a fourth D choice of the multiple choice third query. For example, a respondent selection of the A choice may add a numeric value of three to a total score of a scorecard SCR.001-SCR.N comprising the exemplary second query record Q.REC.002, a respondent selection of the B choice may add a numeric value of zero to the instant total score, a respondent selection of the C choice may add a numeric value of eight to the instant total score, and a respondent selection of the D choice may add a numeric value of five to the instant total score.

Referring now generally to the Figures and particularly to FIG. 1C, FIG. 1C illustrates an exemplary first scorecard record SCR.REC.001 of a scorecard library maintained by the server 104. The first scorecard record SCR.REC.001 includes a first scorecard record identifier SCR.REC.ID.001, a first scorecard identifier SCORE.ID.001 a plurality of query records Q.REC.001-Q.REC.N, an optional notation of a first author data AUTH.001 that identifies an original or identified author of the first scorecard record SCR.REC.001, an optional history of use data HIST.001 of the first scorecard record SCR.REC.001, and a first counter CTR.001 that specifies the number of query records Q.REC.001-Q.REC.N included in the first scorecard record SCR.REC.001. It is understood that the exemplary count of six query records Q.REC.001 of the exemplary first scorecard record SRC.REC.001 choices is chosen for the purpose of clarity of explanation and is not meant as limiting nor specifying a required number of queries to be included within a scorecard record SRC.REC.001-SRC.REC.N of the first method.

The first scorecard record SCR.REC.001 further optionally includes a plurality of weighting factors WT.001-WR.N that are each separately and individually associated with an individual query record Q.REC.001-Q.REC.N that may be applied in generating a total score of a respondent's submitted scorecard SCR.SUB.001-SCR.SUB.N.

It is understood that a scorecard record SCR.REC.001-SCR.REC.N may include a single query text data Q.TXT.001-Q.TXT.N and/or a single query graphics data Q.GRX.001-Q.GRX.N.

Referring now generally to the Figures and particularly to FIG. 1D, FIG. 1D illustrates an exemplary first submitted scorecard record SUB.REC.001 of the submitted scorecard library SUB.LIB maintained by the server 104. The exemplary first submitted scorecard SUB.REC.001 includes a plurality of respondent submitted answers ANS.001-ANS.N to individual queries as derived from the associated query records Q.REC.001-Q.REC.N identified by a plurality of query identifiers Q.ID.001-Q.ID.N included within the first submitted scorecard record SUB.REC.001-SUB.REC.N.

The first submitted scorecard record SUB.REC.001 further includes a first submitted scorecard record identifier SUB.REC.ID.001, a submitted scorecard identifier SUB.ID.001, a respondent identifier R.ID, a first score SCORE.001 derived from the answers ANS.001-ANS.006 and the first score record identifier SCR.ID.001 of an exemplary first scorecard record SRC.REC.001 from which the query records Q.REC.001-Q.REC.N were referenced and/or sourced. More particularly first scorecard identifier SCR.ID.001 is the identifier of the scorecard record SCR.REC.01-SCR.REC.N from which the queries associated with the exemplary first submitted scorecard record SUB.REC.001 were specified.

The exemplary first submitted scorecard record SUB.REC.001 represents a digitized and archived set of answers received as a result of a respondent reviewing the queries specified by the first scorecard record SCR.REC.001 of FIG. 1C and thereto providing answers ANS.001-ANS.006 to the server 104.

Referring now generally to the Figures and particularly to FIG. 1E, FIG. 1E illustrates the scorecard database management system 102 (hereinafter, “the DBMS” 102) of the server 104, that includes the query library Q.LIB of the query records Q.REC.001-Q.REC.N, the scorecard record library SCR.LIB of scorecard records SCR.REC.001-SCR.REC.N that each preferably contain one or more query records Q.REC.001-Q.REC.N, the submitted scorecard library SUB.LIB of submitted scorecard records SUB.REC.001-SUB.REC.N that each preferably contain answers to queries that are referenced by query records Q.REC.001-Q.REC.N, a buyer profile database BP.DB, and a supplier profile database SP.DB.

Referring now generally to the Figures and particularly to FIG. 1E and FIG. 1F, FIG. 1F presents an exemplary first buyer profile record BP.REC.001 and an exemplary Nth buyer profile record BP.REC.N of an exemplary first buyer profile database BP.DB.001, wherein the first buyer profile record BP.REC.001 includes a first buyer identifier BP.ID.001, a first buyer network address BP.ADDR.001 of the enquirer system 111, a listing of scorecard identifiers SCR.ID.001-SCR.ID.N previously authored, accessed or used by the buyer entity referenced by the buyer entity identified by the first buyer identifier BP.ID.001, a listing of submitted scorecard records SUB.REC.001-SUB.REC.N previously accessed by the buyer entity referenced by the first buyer identifier BP.ID.001, and a first buyer historical data BHIST.001 that records buyer interactions with the invented system 100.

Referring now generally to the Figures and particularly to FIG. 1E and FIG. 1G, the exemplary first supplier profile database SP.DB.001 includes an exemplary first supplier profile record SP.REC.001 and an exemplary Nth supplier profile record SP.REC.N. The exemplary first supplier profile record SP.REC.001 includes a first supplier identifier S.ID.001, a first supplier network address SP.ADDR.001, a first supplier category code SCODE.001, and a listing of query identifiers Q.ID.001-Q.ID.N and associated supplier answers ANS.001-ANS.N of queries previously answered by the supplier entity identified by the first supplier identifier S.ID.001. The first supplier category code SCODE.001 and/or one or more supplier category codes SCODE.001-SCODE.N of additional supplier profiles records SP.REC.002-SP.REC.N may be a supplier category code in conformance with an industrial classification system, such as the Standard Industrial Classification System (hereinafter “SIC”) or the North American Industry Classification System (hereinafter, “NAICS”) issued, published and maintained by the United States Government.

One or more supplier profiles records SP.REC.001-S.REC.N may further optionally include a supplier historical data SHIST.001-SHIST.N of supplier interaction with the invented system 100 that optionally includes scorecard identifiers SCR.ID.001-SCR.ID.N and/or submitted scorecard identifiers SUB.ID.001-SUB.SCR related to queries and answers previously addressed and generated by the supplier entity identified by the supplier identifier S.ID.001-S.ID.N of the comprising supplier profile record SP.REC.001-SP.REC.N.

Referring now generally to the Figures and particularly to FIG. 1H, FIG. 1H is a representation of an exemplary first buyer database management system BDBMS.001 of the enquirer system 111. The first buyer database management system BDBMS.001 (hereinafter, “first BDBMS” BDBMS.001) includes a first buyer query library BQ.LIB.001, a first buyer scorecard library BSCR.LIB.001 and a first buyer submitted scorecard library BSUB.LIB.001. The first buyer query library BQ.LIB.001 includes a one or more query identifiers Q.ID.001-Q.ID.N previously applied by the first enquirer system 11 land optionally data harvested from query records Q.REC.001-Q.REC.N. The first buyer scorecard library preferably BSCR.LIB.001 includes one or more scorecard identifiers SCR.ID.001-SCR.ID.N and data harvested from scorecard records SCR.REC.001-SCD.REC.N previously authored, accessed or applied by the enquirer system 111. The first buyer submitted scorecard library BSUB.LIB.001 includes the submitted scorecard identifiers SUB.ID.001-SUB.ID.N and data harvested from submitted scorecard records SUB.REC.001-SUB.REC.N previously accessed by the enquirer system 111.

The first buyer BDBMS BDBMS.001 further optionally includes a listing of supplier identifiers S.ID.001-S.ID.N each preferably paired and associated with at least one unique supplier network address S.ADDR.001-S.ADDR.N of the respondent system 105 or a supplier system 106, 108 & 110.

Referring now generally to the Figures and particularly to FIG. 1I, FIG. 1I is a representation of an exemplary first supplier database management system BDMS.001 of the respondent system 105. The first supplier database management system SDBMS.001 (hereinafter, “first SDBMS” SDBMS.001) includes a first supplier query library SQ.LIB.001, a first supplier scorecard library SSCR.LIB.001 and a first supplier submitted scorecard library SSUB.LIB.001. The first supplier query library SQ.LIB.001 includes a one or more query identifiers Q.ID.001-Q.ID.N each associated with one specific answer ANS.001-ANS.N previously supplied by the entity associated with the first supplier identifier S.ID.001 and optionally additional data harvested from query records Q.REC.001-Q.REC.N. It is understood that one or more query identifiers Q.ID.001-Q,ID.N may be associated with more than one previously submitted answers ANS.001-ANS.N and an associated time date stamp TDS.001-TDS.N of each previously submitted answers ANS.001-ANS.N.

The first supplier scorecard library preferably SSCR.LIB.001 includes one or more scorecard identifiers SCR.ID.001-SCR.ID.N and optional data harvested from scorecard records SCR.REC.001-SCD.REC.N previously authored, accessed or applied by the respondent system 105. The first supplier submitted scorecard library SSUB.LIB.001 includes the submitted scorecard identifiers SUB.ID.001-SUB.ID.N and data harvested from submitted scorecard records SUB.REC.001-SUB.REC.N previously submitted by the respondent system 105 to the server 104 and./or the enquirer system 111 or the buyer systems 112, 114 & 116.

The first supplier SDBMS SDBMS.001 further optionally includes a listing of buyer identifiers B.ID.001-B.ID.N each preferably paired and associated with at least one unique buyer network address B.ADDR.001-B.ADDR.N of an enquirer system 111 or a buyer system 112, 114 & 1116.

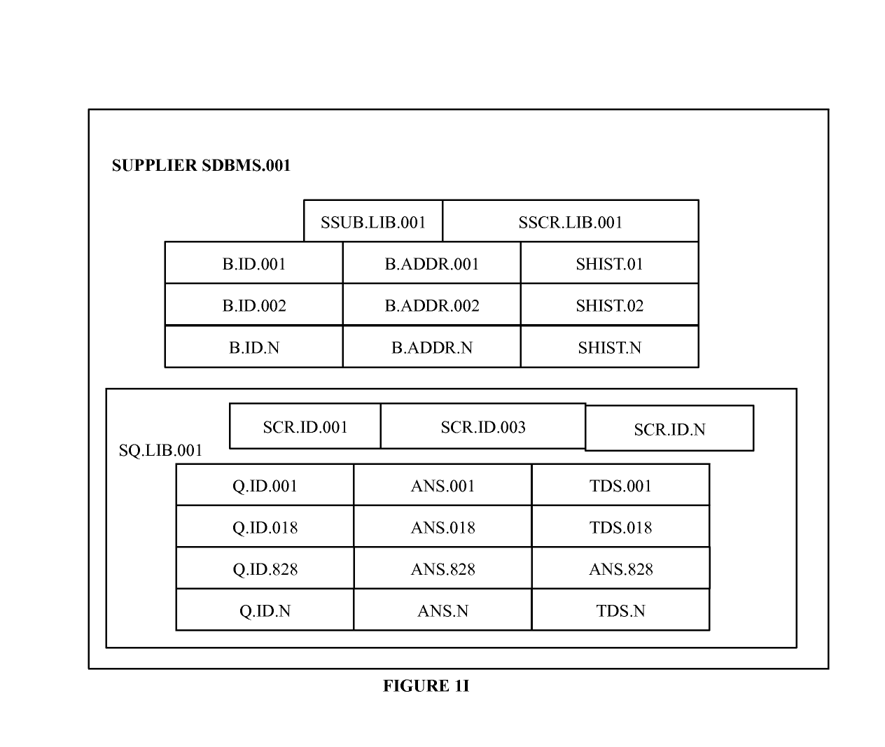

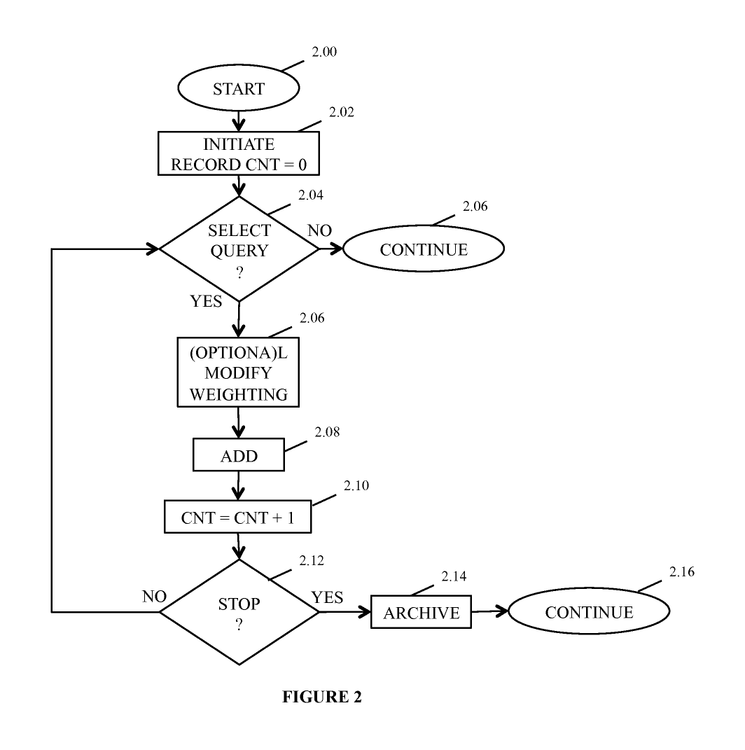

Referring now generally to the Figures and particularly to FIG. 2, FIG. 2 is a representation of the enquirer system 111 as directed by first system user in populating a new scorecard record SRC.REC.001-SRC.REC.N. In step 2.02 the enquirer system 111 set a counter equal to zero and in the loop of steps 2.04 through 2.12 the first user directs the enquirer system 111 to select a query record Q.REC.001-Q.REC.N (step 2.04) optionally modify the weighting WT.001-WT.N of the last selected query record Q.REC.001-Q.REC.N in step 11.06 from a default weighting, and add the last selected query record Q.REC.001-Q.REC.N to the new scorecard record SRC.REC.001-SRC.REC.N in step 2.10. The enquirer system 111 increments the counter CNT in step 2.10, and as directed by the first user proceeds onto either (a.) another performance of the loop of steps 2.04 through 2.12, or to archive the new scorecard record SRC.REC.001-SRC.REC.N, including the current value of the counter CNT, at both the enquirer system 111 and the server 104 in step 2.14. It is understood that a scorecard record SCR.REC.001-SCR.REC.N may include only one query text data Q.TXT.001-Q.TXT.N and/or only one query graphics data Q.GRX.001-Q.GRX.N.

The enquirer system 111 then proceeds from step 2.14 to step 2.16 and to perform alternate computational operations.

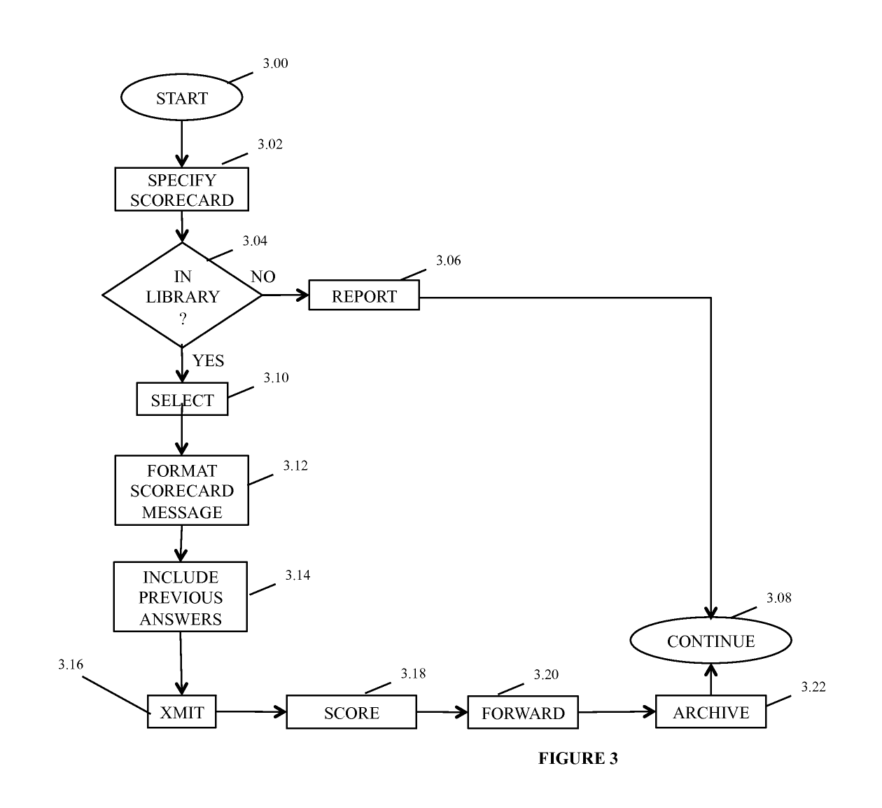

Referring now generally to the Figures and particularly to FIG. 3, FIG. 3 is a representation of the server 104 engaging with the network 100 in generating a submitted scorecard record SUB.REC.001-SUB.REC.N. In step 3.02 the server 104 receives an exemplary scorecard request message R.SCR.MSG that includes a supplier identifier S.ID.001-S.ID.N of the enquirer system 111 and specifies a scorecard record SCR.REC.001-SCR.N. The server 104 determines in step 3.04 if the scorecard record SCR.REC.001-SCR.REC.N identified in step 3.02 is in the scorecard library SCR.LIB.

If the referenced scorecard record SCR.REC.001-SCR.REC.N is not found in step 3.04, the server 104 reports this failure to the enquirer system 111 in step 3.06 and proceeds on to other computational operations of step 3.08. In the alternative, if the referenced scorecard record SCR.REC.001-SCR.REC.N is found in step 3.04, the server 104 selects the referenced scorecard record SCR.REC.001-SCR.REC.N in step 3.10 and finds the supplier network address S.ADDR.001-S.ADDR.N associated with the supplier identifier S.ID.001-S.ID.N specified scorecard request message R.SCR.MSG received in step 3.02.

The server 103 next formats a scorecard message SCR.MSG in step 3.12 wherein the exemplary scorecard message SCR.MSG is addressed to the buyer system 105-110 identified in the scorecard request message R.SCR.MSG of step 3.02. The server 104 further populates the SCR.MSG with a query text data Q.TXT.001-Q.TXT.N and/or a query graphics data Q.GRX.001-Q.GRX.N of the selected scorecard record SCR.REC.001-SCR.REC.N. It is understood that a scorecard record SCR.REC.001-SCR.REC.N may include only one query text data Q.TXT.001-Q.TXT.N and/or only one query graphics data Q.GRX.001-Q.GRX.N.

In step 3.14 the server 104 searches the supplier profile database SP.DB.001 for any instances of the supplier identified in the scorecard request message R.SCR.MSG having previous answers to any query encoded into the query records Q.REC.001-Q.REC.N included in the selected scorecard record SCR.REC.001-SCR.REC.N, including answers to the queries of equivalent query records Q.REC.001-Q.REC.N. Any relevant previously provided answers noted in the supplier profile database SP.DB.001 as having been supplied by the supplier identified in the scorecard request message R.SCR.MSG are added to the SCR.MSG in step 3.14 and in association with its associated query text data Q.TXT.001-Q.TXT.N and/or query graphics data Q.GRX.001-Q.GRX.N.

The scorecard message SCR.MSG is then transmitted in step 3.16 to the to the buyer system 105-110 identified in the scorecard request message R.SCR.MSG of step 3.02.

When and if a submittal response message RESP.MSG is received by the server 104 in step 3.18, the server 104 generates a submittal scorecard record SUB.REC.001-SUB.REC.N and calculates a score SCORE of the newly generated submittal scorecard record SUB.REC.001-SUB.REC.N. The server 104 then transmits the received answers ANS.001-ANS.N of the response message RESP.MSG the score SCORE of the newly generated submittal scorecard record SUB.REC.001-SUB.REC.N to the enquirer system 111 in a reply message REPLY.MSG in step 3.10. The server next archives the newly generated scorecard record SUB.REC.001-SUB.REC.N in step 3.22. The server 104 proceeds from step 3.22 on to perform other computation operations of step 3.08.

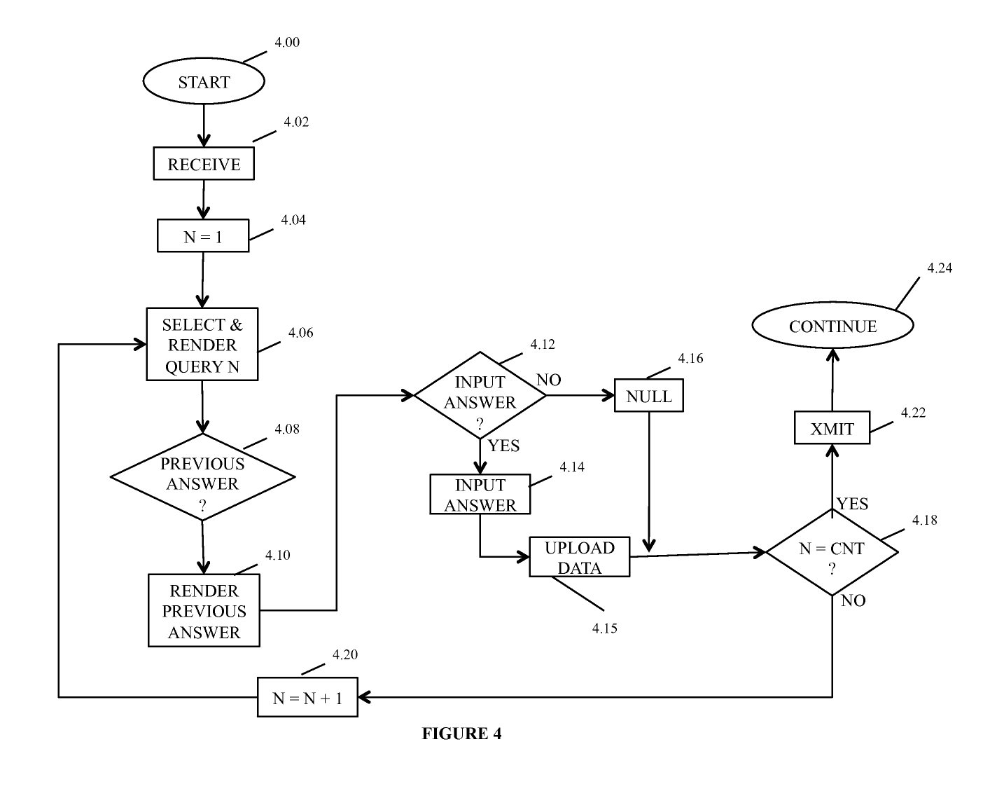

Referring now generally to the Figures and particularly to FIG. 4, FIG. 4 is a representation of the respondent system 105 responding to receipt of the query data Q.TXT.001-Q.TXT.N & Q.GRX.001-GRX.N of the exemplary scorecard message SCR.MSG as directed by a responding user. In step 4.02 the respondent system 105 detects a receipt of a query count CNT and a set of query data Q.TXT.001-Q.TXT.N & Q.GRX.001-GRX.N and exemplary previously provided answers ANS.001 ANS.018 as provided in the exemplary scorecard message SCR.MSG. The respondent system 105 sets a loop counter n to be equal to a one value and the selects and renders the first query text data Q.TXT.001 and the first query graphics data Q.GRX.001 of the exemplary scorecard message in step 4.06. Previous answer ANS.001 associated with first query text data Q.TXT.001 is detected in step 4.08 and is additionally rendered by the respondent system 105 in step 4.10. The responding user the directs the respondent system 105 in step 4.12 to (a.) accept and input the previously supplied answer ANS.001, (b.) accept and input a different answer, or (c.) accept and input a null answer. The answer input in step 4.14 is recorded into the exemplary response message RESP.MSG and in optional step 4.15 a responding user may upload additional data RESP.DATA,001-RESP.DATA.N into and a scorecard message SCR.MSG, such as images, video data, textual documents, numeric data, and formatted documents such as in conformance with WORD™ word processing system as marketed by Microsoft Corporation, or the PDF™ document format as marketed by Adobe Corporation. In alterative step 4.16, the responding user directs the respondent system 105 to enter a no answer, i.e., a null response. In step 4.18 the respondent system 105 determines that the loop counter is not equal to the count CNT of queries. The loop counter N is then incremented in step 4.20.

In a second iteration of the loop of steps 4.06 through 4.20 renders the second query text data Q.TXT.002 and the second query graphics data Q.GRX.002 in step 4.06, and furthers renders the equivalent answer ANS.018 in the second execution of step 4.10. The responding user then directs the respondent system 105 in the second execution of step 4.12 to (a.) accept and input the previously supplied answer ANS.018, (b.) accept and input a different answer, or (c.) accept and input a null answer. The respondent system 105 iterates through the loop of steps 4.06 through 4.20 until each query text data Q.TXT.001-Q.TXT.N and graphics data Q.GRX.001-Q.GRX.N of the exemplary scorecard message SCR.MSG has been rendered by the respondent system 105 and responded to by the responding user. As directed by the responding user, the respondent system 105 then transmits the populated response message RESP.MSG to the server 104 in step 4.22 and proceeds on to perform alternate computational operations on step 4.24.

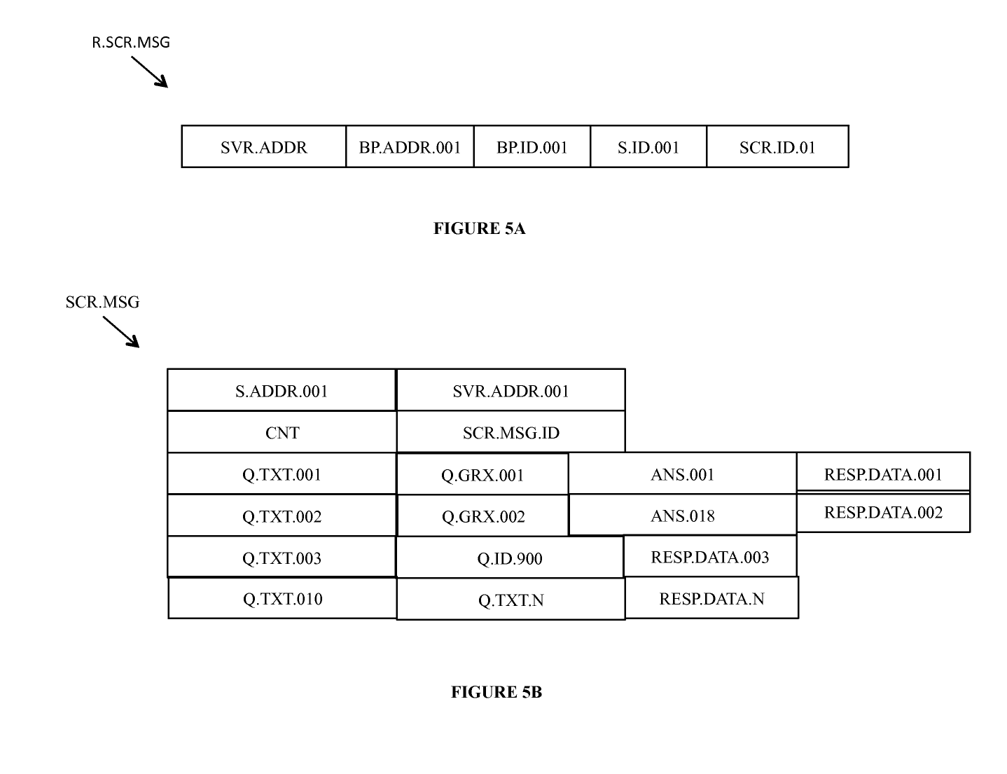

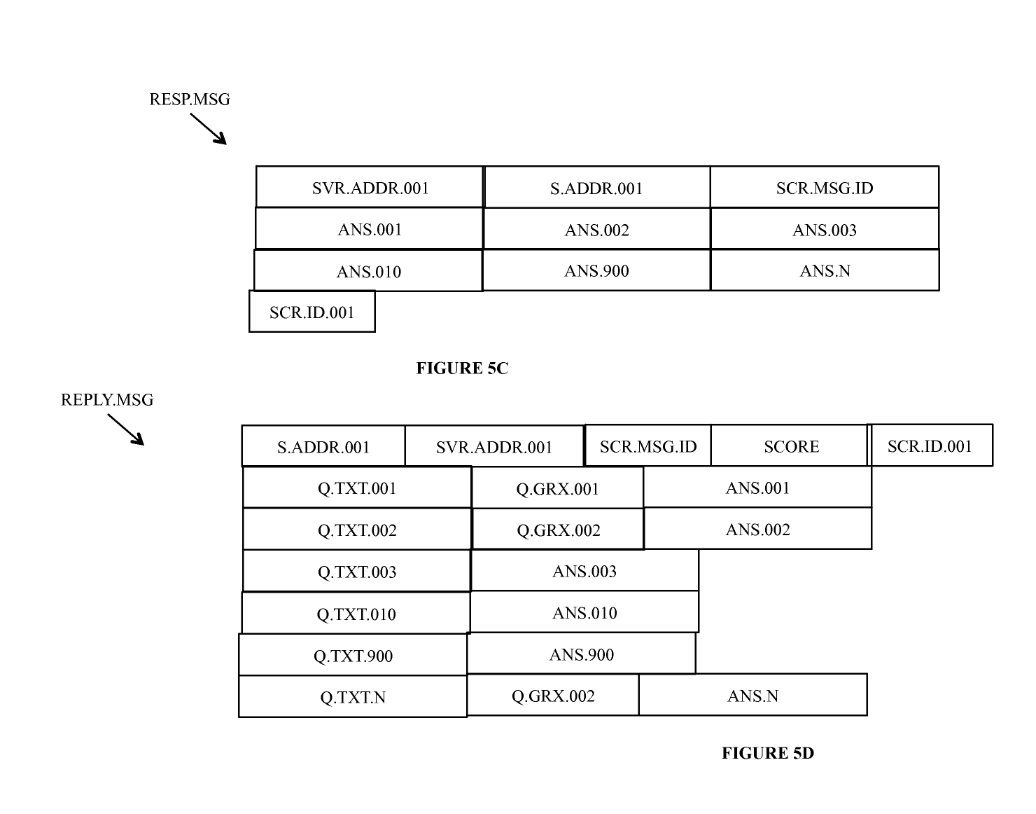

Referring now generally to the Figures and particularly to FIG. 5A, FIG. 5A is a block diagram of the exemplary scorecard request message R.SCR.MSG. The scorecard request message R.SCR.MSG includes a network address of the server 104 SVR.ADDR.001 as a destination address, the network address of the enquiring system BP.ADDR.001 as the sender address, the identifier of the enquiring entity BP.ID.001, the identifier of the exemplary first supplier S.ID.001and the identifier of the exemplary first scorecard SCR.ID.001.

Referring now generally to the Figures and particularly to FIG. 5B, FIG. 5B is a block diagram of the exemplary score card message SCR.MSG. The scorecard message SCR.MSG includes the network address of the respondent system S.ADDR.001 as the destination address, a network address of the server 104 SVR.ADDR.001 as a sender address, a query counter CNT equaling the number of queries provided in the score card message SCR.MSG (six in this case of the first exemplary scorecard record SCR.REC.001), a unique scorecard message identifier SCR.MSG.ID, and the query text data Q.TXT.001-Q.TXT.N and optionally graphics data Q.GRX.N.

Referring now generally to the Figures and particularly to FIG. 5C, FIG. 5C is a block diagram of the response message RESP.MSG. The response message RSP.MSG includes the network address SVR.ADDR of the server 104 as the destination address, the network address the respondent system S.ADDR.001 as a sender address, the unique scorecard message identifier SCR.MSG.ID of the related scorecard message SCR.MSG, and six individual answers ANS.001-ANS.N to the first queries of the first exemplary scorecard record SCR.REC.001. It is noted the responding user in this instance of the exemplary response message RESP.MSG input the previously supplied first answer ANS.001 but elected to not input an equivalent alternate answer ANS.018 associated with the second query text data Q.TXT.002 but in the alternative input a new second answer ANS.002.

Referring now generally to the Figures and particularly to FIG. 5D, FIG. 5D is a block diagram of the exemplary reply message REPLY.MSG of step 3.20 of the process of FIG. 3.The exemplary REPLY.MSG includes the network address B.ADDR.001 of the enquirer system 111 as the destination address, the network address SVR.ADDR.001 of the server 104 as the sender address, the score SCORE calculated in step 3.18, the relevant unique scorecard message identifier SCR.MSG.ID, the query text data Q.TXT.001-Q.TXT.N, graphics data Q.GRX.N and answers ANS.001-ANS.N of the associated exemplary scorecard message and response message RESP.MSG. The enquiring user may thus render the answers to the queries as intended in step 3.02.

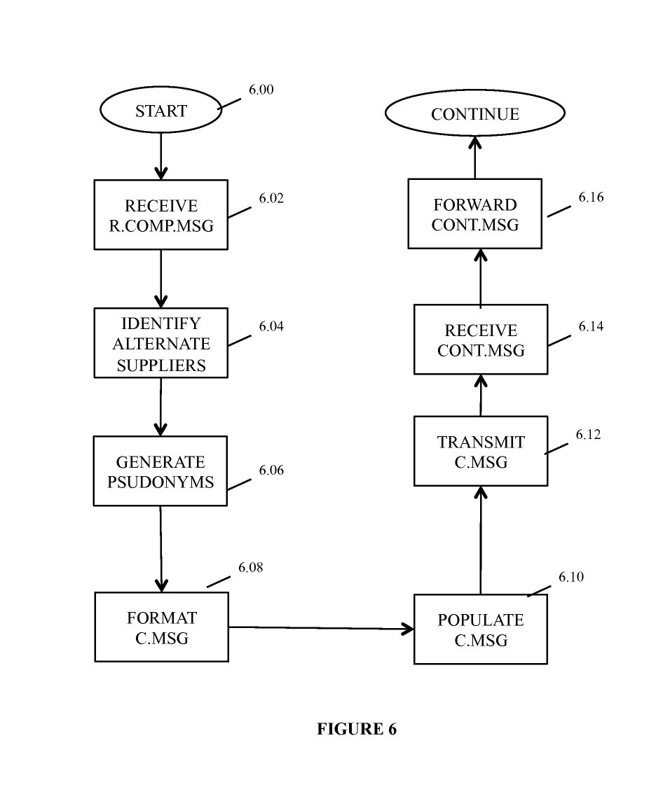

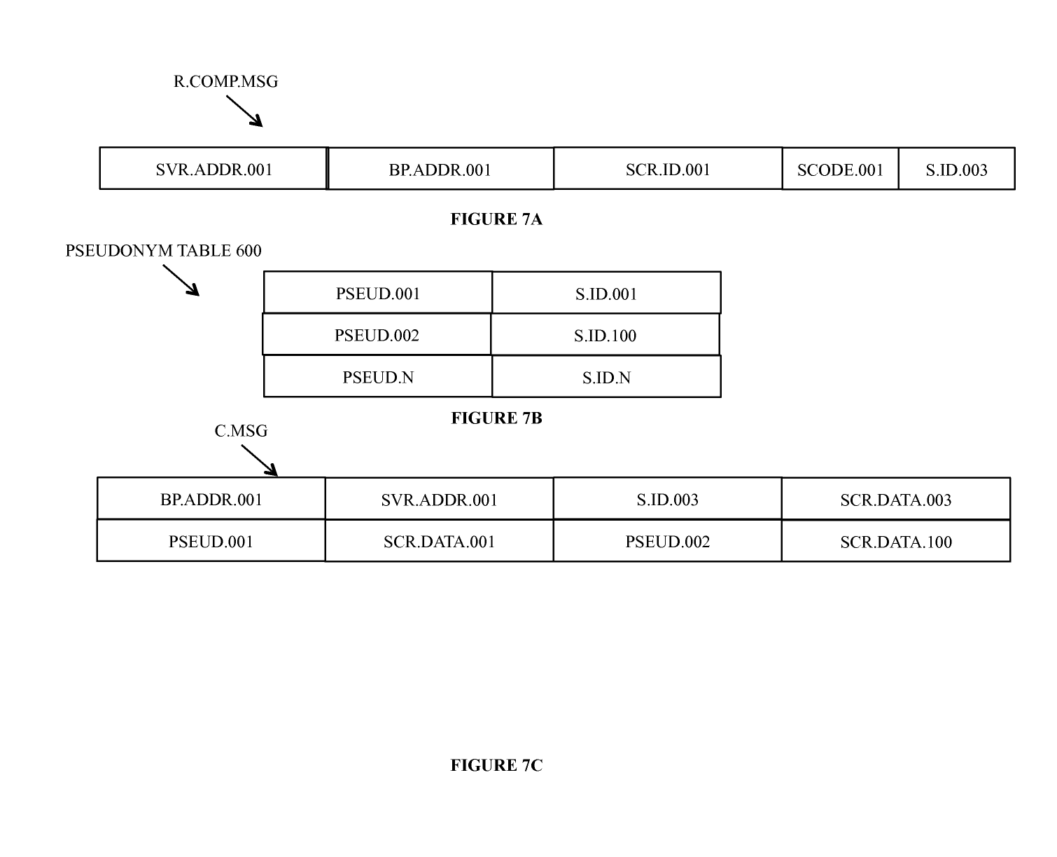

Referring now generally to the Figures and particularly to FIG. 6, FIG. 6 is a flowchart of a comparison process wherein an enquiring party may compare query and scorecard answers of a known supplier with other unidentified suppliers without disclosing the identities of the unidentified suppliers. In step 6.02 the server 104 receives an exemplary compare request message R.COMP.MSG from the enquirer system 111 that identifies a known supplier with a third supplier identifier S.ID.003, and includes the exemplary first scorecard record identifier SCR.REC.ID.001, and provides an exemplary first supplier category code SCODE.001. In step 6.04 the server 104 searches the supplier profile database SP.DB.001 and looks for any supplier profile records SP.REC.001-SP.REC.N that reference both the first scorecard record identifier SCR.REC.ID.001 and the first supplier category code SCODE.001. In step 6.06 the server 104 generates distinguishable pseudonyms PSEUD.001& PSEUD.002 for each supplier identifier S.ID.001 & S.ID.100 determined to be associated with both the first scorecard record identifier SCR.REC.ID.001 and the first supplier category code SCODE.001. The association of each distinguishable pseudonym PSEUD.001& PSEUD.002 with each individual supplier identifier S.ID.001 & S.ID.100 is maintained in a pseudonym table 600 of FIG. 7B.

In step 6.08 the server 104 harvests query data Q.TXT.001-Q.TXT.N & Q.GRX-GRX.N FROM each submitted scorecard record SUB.REC.001-SUB.REC.N that are both (a.) associated with and derived in view of the first scorecard record SCR.REC.001, and (b.) associated with the suppliers identified by the pseudonyms of step 6.06. An exemplary comparison data message C.MSG is formatted in step 6.10 and populated with the pseudonyms of step 6.06 and the data harvested in step 6.08. The comparison data message C.MSG is sent to the enquirer system 111 in step 6.12.

In optional step 6.14 the server 104 receives a contact request message CONT.MSG from the first enquirer system 111 and forwards on the contact request message CONT.MSG to the supplier system 105-110 indicated by a pseudonym PSEUD.001 & PSEUD.002 provided in the contact request message CONT.MSG. The server 104 then proceeds from step 6.16 to step 6.18 and to perform alternate computational operations.

Referring now generally to the Figures and particularly to FIG. 7A, FIG. 7A is a block diagram of the exemplary comparison request message R.COMP.MSG of step 6.02. The comparison request message R.COMP.MSG includes the server network address SVR.ADDR of the network server 104 as the destination address and the first enquirer system network address BP.ADDR.001 as the sender address. The comparison request message R.COMP.MSG further contains the third supplier identifier S.ID.003, the exemplary first scorecard identifier SCR.ID.001, and provides an exemplary first supplier category code SCODE.001.

Referring now generally to the Figures and particularly to FIG. 7B, FIG. 7B is a block diagram of the pseudonym table 600 of step 606 as maintained by the server 104 and that associates pseudonyms PSEUD.001 & PSEUD.002 with assigned supplier identifiers S.ID.001 & S.ID.100.

Referring now generally to the Figures and particularly to FIG. 7C, FIG. 7C is a block diagram of the exemplary comparison data message C.MSG of steps 6.08 through 6.12 and as sent to the enquirer system 111 from the server 104. The first pseudonym PSEUD.001 is associated by the server 104 with a first scorecard data SCR.DATA.001 and a second pseudonym PSEUD.002 is associated by the server with a second scorecard data SCR.DATA.100. The third scorecard data SCR.DATA.003 is associated with data extracted from a submitted scorecard record SUB.REC.001-SUB.REC.N that was previously provided by the supplier identified by the third supplier identifier S.ID.003.

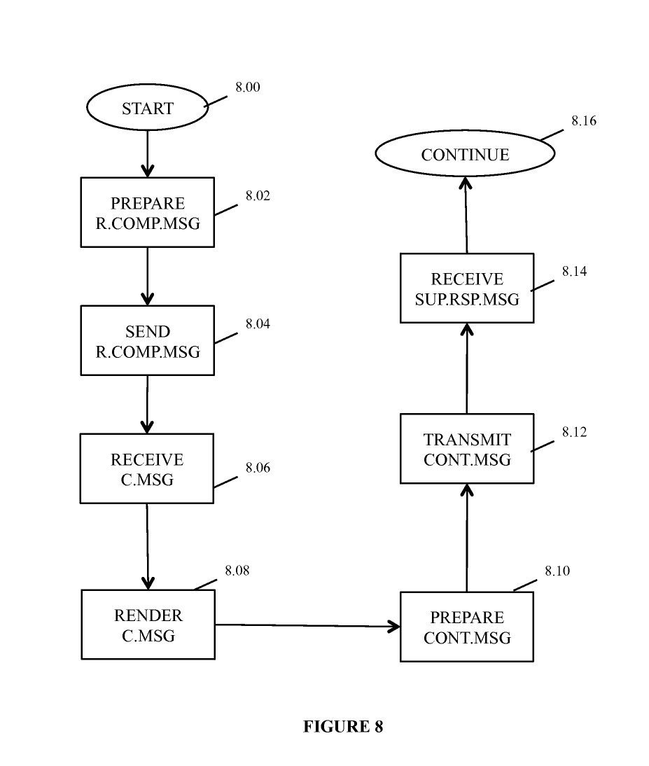

Referring now generally to the Figures and particularly to FIG. 8, FIG. 8 is a software flowchart of interaction of the enquirer system 111 and the enquiring user with the server 104. In step 8.02 the enquirer system 111 formats and populates the comparison request message R.COMP.MSG and sends the comparison request message R.COMP.MSG to the server 104 in step 8.04. The enquirer system 111 receives the comparison message C.MSG from the server 104 in step 8.06 and visually renders data of the comparison message C.MSG in step 8.08. In step 8.10 the enquirer system 111, as directed by the enquiring user, prepares and populates a contact request message CON.MSG that specifies the pseudonym PSEUD.100 of a supplier with whom the enquiring user desires to communicate. The enquirer system 111 may receive a supplier response message SUP.RSP.MSG from the relevant supplier associated with the pseudonym PSEUD.100 in step 8.14 included in the contact request message CON.MSG of step 8.10.

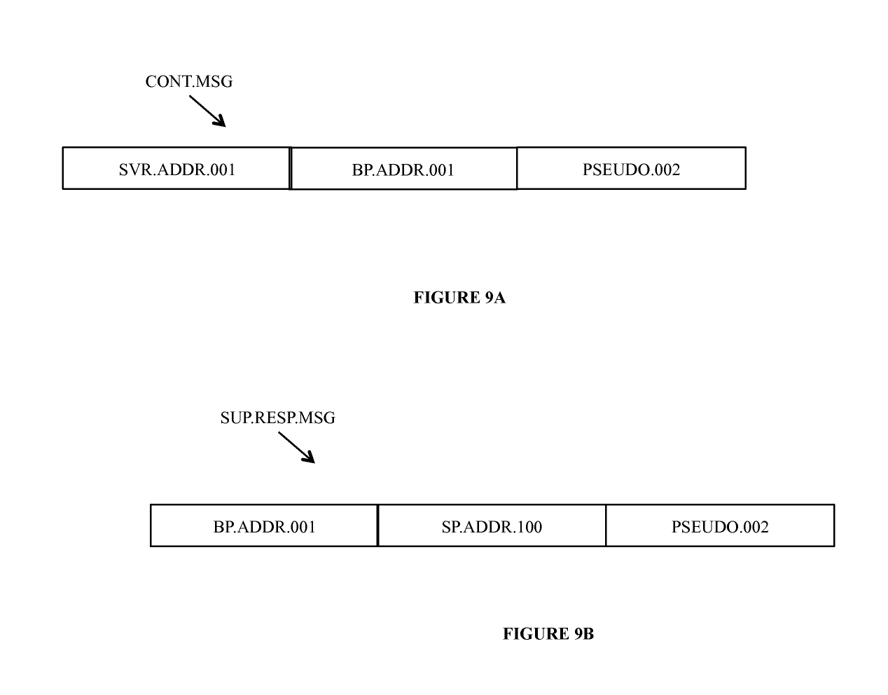

Referring now generally to the Figures and particularly to FIG. 9A, FIG. 9A is a block diagram of the contact request message CONT.MSG of step 8.10. The contact request message CONT.MSG includes the server network address SVR,ADDR as the destination address, the enquiring system network address BP.ADDR.001 as the sender address, and the selected second pseudonym PSEUD.002.

Referring now generally to the Figures and particularly to FIG. 9B, FIG. 9B is a block diagram of the supplier response message SUP.RSP.MSG of step 8.14. The supplier response message SUP.RSP.MSG includes the enquiring system network address BP.ADDR.001 as the destination address, the supplier network address SP.ADDR.100 of the RESPONDING SUPPLIER, and the selected second pseudonym PSEUD.002. Upon receipt of the supplier response message SUP.RSP.MSG by the enquiring system 111, the enquiring user may directly communicate with the responding supplier.

Referring now generally to the Figures and particularly to FIG. 10, FIG. 10 is a representation of the enquirer system 111 accessing selected data of the supplier profile records SP.REC.001-SP.REC.N as enabled by the server 104 by application of the pseudonym table 600 and without revealing the identity of suppliers. The enquire system 111 selects a pseudonym PSEUD.001-PSEUD.N in step 10.04 and sends a relevant second contact request CONT.MSG.002 to the server 104 and specifying the Nth pseudonym PSEUD.N in step 10.06. The enquirer system 111 receives a contact approval in step 10.08 and is then enabled by the server 104 in step 10.10 to retrieve data from the supplier profile database SP.DB.001 and other information related to the Nth supplier.

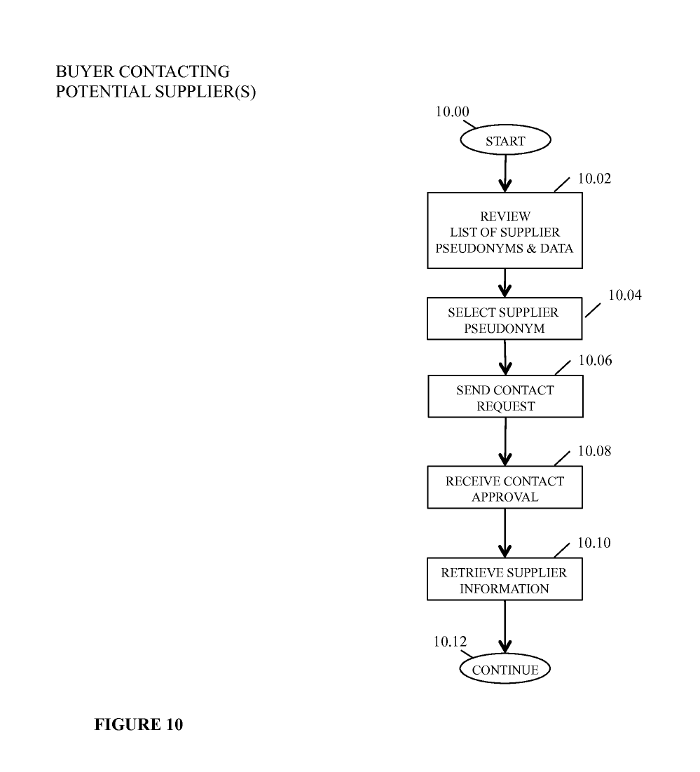

Referring now generally to the Figures and particularly to FIG. 11, FIG. 11 is a flowchart of the respondent system in interaction with the server 104 in conducting a comparison of its answers ANS.001-ANS.N to answers provided by other suppliers of a specified industry to the same queries. In step 11.02 the respondent system 105 prepares the assessment request message ASSESS.MSG of step 11.02 and sends the assessment request message ASSESS.MSG in step 11.04. The respondent system 105 receives a self assessment data message SA.MSG in step 11.06 and in step 11.08 renders the data provided. The respondent system 105 proceeds from step 11.08 to step 11.10 and to perform alternate computational operations.

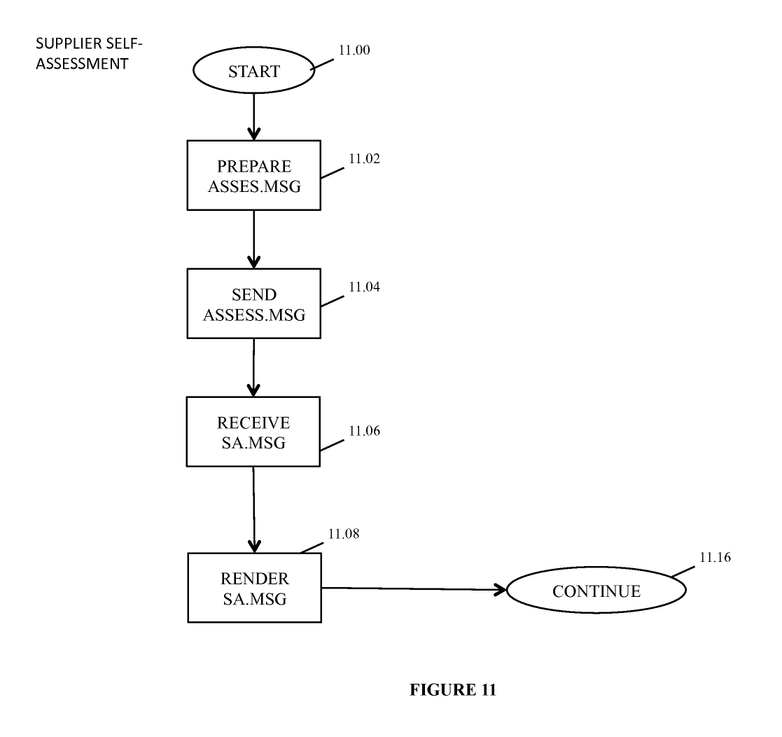

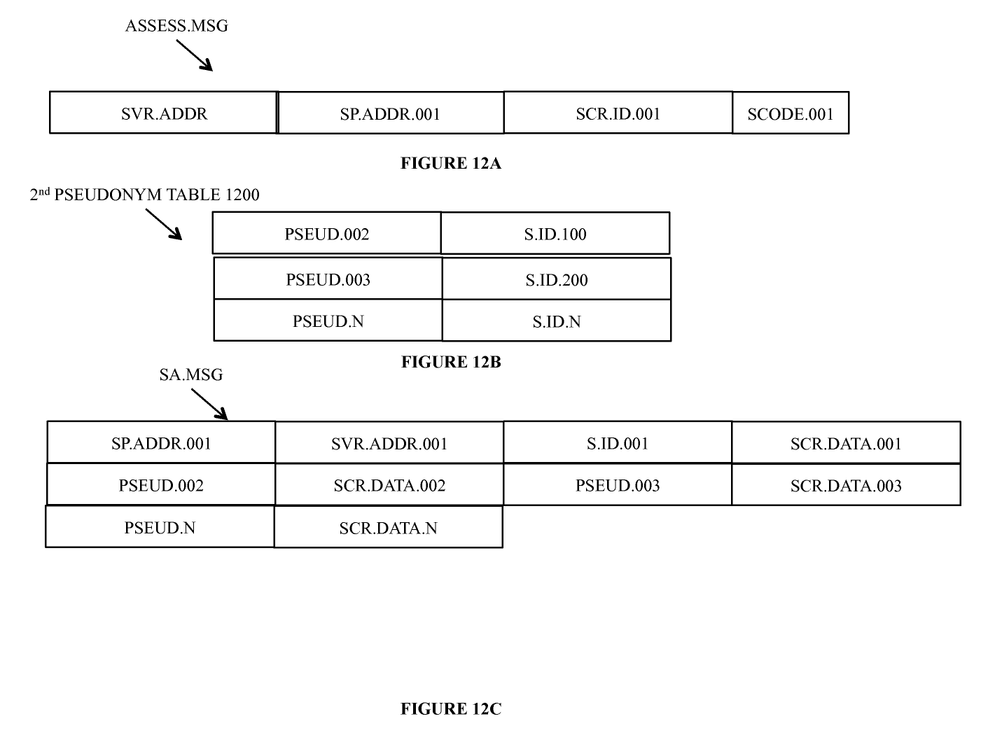

Referring now generally to the Figures and particularly to FIG. 12A, FIG. 12A is a block diagram of the exemplary self assessment message ASSESS.MSG of step 11.02 addressed to the server 104 at the server network address SVR.ADDR.001. The respondent system network address is included as the sender address SP.ADDR.001, as is the first scorecard identifier SCR.ID.001 and first supplier category code SCODE.001 are included in the self assessment message ASSESS.MSG.

Referring now generally to the Figures and particularly to FIG. 12B, FIG. 12B is a block diagram of the second pseudonym table 1200 as maintained by the server 104 and that individually and separately associates pseudonyms PSEUD.002, PSEUD.003 & PSEUD.N with assigned supplier identifiers S.ID.100, S.ID.200 & S.ID.N. It is understood that the pseudonyms PSEUD.002, PSEUD.003 & PSEUD.N and the SECOND pseudonym table 1200 are non-persistent and are preferably used within only one instance to relate to any particular entity, server 104, system 105-116, or data structure.

Referring now generally to the Figures and particularly to FIG. 12C, FIG. 12C is a block diagram of the exemplary self assessment data message SA.MSG of steps 11.06 and 11.08 and as sent to the respondent system 105 from the server 104. The self assessment data message SA.MSG includes the respondent system network address BP.ADDR.001 as the destination address and the server network address SVR.ADDR as the sender address.

The self assessment data message SA.MSG includes data related to the respondent system 105 and in association with the specified scorecard identifier, e.g., the exemplary first scorecard identifier SCR.ID.001. A nonpersistent first pseudonym PSEUD.002 is associated with a first scorecard data SCR.DATA.100, a second nonpersistent pseudonym PSEUD.003 is associated with a second scorecard data SCR.DATA.20, and another Nth pseudonym PSEUD.N is associated with an Nth scorecard data SCR.DATA.N. It is understood in preparing the self assessment data record SA.MSG the server 104 follows the processes steps 6.04 and 6.06 wherein the server 104 searches the supplier profile database SP.DB.001 and looks for and selects only from supplier profile records SP.REC.001-SP.REC.N that reference both the first scorecard record identifier SCR.REC.ID.001 and the first supplier category code SCODE.001. It is understood that the pseudonyms PSEUD.001 & PSEUD.002 and the pseudonym table 600 are non-persistent and are preferably used within only one instance to relate to any particular entity, server 104, system 105-116, or data structure.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A computer-implemented method comprising:
a. making a plurality of queries accessible via an electronic communications network;
b. associating previously received answers to queries in separate association with each respondent that provided each previously received answer;
c. receiving a request from an enquirer to direct a new instance of a first query to a specified respondent;
d. determining that the specified respondent has previously supplied an answer to the first query; and
e. transmitting the first query in association with the previously supplied an answer to the specified respondent.

2. The computer-implemented method of claim 1, further comprising;
f. receipt of a selection of the previously supplied answer to the first query from the specified respondent; and
g. forwarding the previously supplied an answer to the enquirer as an answer to the current instance of the first query.

3. The computer-implemented method of claim 1, further comprising;
f. receipt of an alternate answer to the first query from the specified respondent; and
g. forwarding the alternate answer to the enquirer as an answer to the current instance of the first query.

4. The computer-implemented method of claim 1, further comprising;
f. associating a second query as being equivalent to the first query;
g. determining that the specified respondent has previously supplied an answer to the second query; and
e. transmitting the first query in association with the previously supplied an answer to the second query to the specified respondent.

5. The computer-implemented method of claim 2, further comprising providing the enquirer with a comparison datum of the previously supplied answer with at least one other answer provided by an alternate respondent in answer to the first query.

6. The computer-implemented method of claim 5, further comprising providing the enquirer with a comparison datum with a pseudonym of the alternate respondent.

7. The computer-implemented method of claim 6, further comprising:
h. receiving a contact request from the enquirer to forward information to the alternate respondent; and
i. forwarding the contact request to the alternate respondent.

8. The computer-implemented method of claim 5, wherein the alternate respondent is selected on the basis of a similarity with the respondent.

9. The computer-implemented method of claim 8, wherein the alternate respondent is selected on the basis of an association with a same industry as the respondent.

10. A computer-implemented method comprising:
a. forming a plurality of queries;
b. designating a subset of queries of the plurality of queries as a first scorecard;
c. enabling access to the first scorecard to an enquirer;
d. transmitting the scorecard to a respondent selected by the enquirer, along with at least one previously supplied answer to a query of the scorecard;
e. receiving a plurality of answers to the subset of queries from the respondent; and
f. forwarding the plurality of answers received from the respondent to the enquirer.

11. The computer-implemented method of claim 10 wherein the at least one previously supplied answer is provided as an answer by the respondent and is forwarded on to the enquirer.

12. The computer-implemented method of claim 10, wherein the at least one previously supplied answer is not provided as an answer by the respondent and an alternate answer is forwarded on to the enquirer.

13. The computer-implemented method of claim 10, further comprising:
g. associating a second query as being equivalent to a first query of the subset of queries;
h. determining that a respondent has previously supplied an answer to the second query; and
i. transmitting the first query in association with the previously supplied an answer to the second query to the respondent.

14. The computer-implemented method of claim 10, further comprising providing the enquirer with a comparison data of the plurality of answers with an other plurality of answers provided by an alternate respondent in answer to the same subset of queries.

15. The computer-implemented method of claim 14, further comprising providing the enquirer with a comparison datum with a pseudonym of the alternate respondent.

16. The computer-implemented method of claim 15, further comprising:
h. receiving a contact request from the enquirer to forward information to the alternate respondent; and
i. forwarding the contact request to the alternate respondent.

17. The computer-implemented method of claim 14, wherein the alternate respondent is selected on the basis of a similarity with the respondent.

18. The computer-implemented method of claim 17, wherein the alternate respondent is selected on the basis of an association with a same industry as the respondent.

19. The computer-implemented method of claim 17, wherein the enquirer is a purchasing entity.

20. A computational system comprising:
a. means to make a plurality of queries accessible via an electronic communications network;
b. means to associate a plurality of previously received answers to queries in separate association with each respondent that provided each previously received answer;
c. means to receive a request from an enquirer to direct a new instance of a first query to a specified respondent;
d. means to determine that the specified respondent has previously supplied an answer to the first query; and
e. means to forward the first query in association with the previously supplied an answer to the specified respondent.
